(19) United States
(12) Patent Application Publication
(10) Pub. No.: US 2016/0272849 A1
(43) Pub. Date: Sep. 22, 2016

(54) TEMPORARY FIXING MATERIAL

(71) Applicant: SEKISUI PLASTICS CO., TLD., Osaka-shi, Osaka (JP)

(72) Inventors: Yasuhiro FUJIWARA, Inashiki-gun (JP); Kazuki KATO, Inashiki-gun (JP)

(73) Assignee: SEKISUI PLASTICS CO., LTD., Osaka-shi, Osaka (JP)

(21) Appl. No.: 14/778,413

(22) PCT Filed: Mar. 25, 2014
(86) PCT No.: PCT/JP2014/058164

§ 371 Date: Sep. 18, 2015

(30) Foreign Application Priority Data
Mar. 29, 2013 (JP) 2013-071329

(51) Int. Cl. C09J 7/02

(52) U.S. Cl. CPC C09J 7/02; C09J 2433/00; C09J 2429/00; C09J 2203/326; C09J 2205/114; C09J 2205/102; C09J 2467/006

(57) ABSTRACT

A temporary fixing material has a temporary fixing performance such that it can be used for temporarily fixing precision electronic parts made of glass, metals, etc. with ease, and which also can be easily removed from the adherend; an ability to remove contaminants before the temporary fixing; and an antistatic performance such that it can remove static electricity occurring at the time of removal thereof. The temporary fixing material includes a base substrate and a polymer gel, usable for temporarily fixing electronic parts during conveyance or processing thereof, a specific polymer gel is utilized which comprises: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; and water having dissolved therein at least polyvinyl alcohol-type polymer, the water being retained in the polymer matrix.

### TECHNICAL FIELD

The present invention relates to a temporary fixing material which can be used for temporarily fixing electronic parts during conveyance or processing thereof. For example, the present invention relates to a temporary fixing material which can be used in the processing or the like of a precision electronic part such as a semiconductor in a clean room for temporarily fixing the semiconductor to a substrate, and can be peeled off after the processing.

### BACKGROUND ART

Conventionally, the production process of precision electronic parts such as a semiconductor (e.g., steps for production, washing, examination and conveyance) is implemented while temporarily fixing various materials etc., by an adhesive such as an adhesive tape. Such an adhesive used for temporary fixing is required to have characteristics such that the adhesive exhibits sufficient adhesion property during the processing of the electronic parts but can be easily removed from the adherend after completion of the processing.

Further, in recent years, as the electronic parts become more precise, the problem of adhesion of contaminants to the surface of the electronic parts has become more serious. For example, in the case of a semiconductor substrate which is a representative example of precision electronic parts, the contaminants on the surface thereof cause an open circuit or a short circuit. Further, a high degree of cleaning may lead to lowering of yield of the products, and a slight amount of contaminant may cause a fetal defect of performance; therefore, it is desired to remove the contaminants from the surface of the electronic parts.

However, adhesives such as an adhesive tape have a strong adhesiveness (peel strength) and, therefore, can be adhered to an adherend with a satisfactory strength, but is difficult to peel from the adherend without damaging the adherend. Further, due to such a strong adhesiveness, when the adhesive is peeled off forcibly, an adhesive residue is left on the adherend, resulting in the adhesion of contaminants to the adherend. On the other hand, when the adhesiveness of the adhesive is lowered for improving the removability, a problem arises that the adhesion to an adherend becomes insufficient to prevent the adherend from being detached during the conveyance or processing, so that the adhesive cannot be used as a temporary fixing material.

As an example of such an adhesive as mentioned above, there can be mentioned a fixing sheet disclosed in Japanese Patent Unexamined Publication No. 2003-105290 (Patent Document 1), which comprises a base material and, provided thereon, a radiation curable adhesive layer. More specifically, according to this document, in an adhesive sheet for fixing during the cutting of a semiconductor sealing resin plate or an optical part, the adhesive layer is composed of 0.02 to 10 parts by weight of an alkyl group-containing ester compound having 10 or more carbon atoms, relative to 100 parts by weight of a base polymer.

Japanese Patent Application Unexamined Publication No. 2012-184292 (Patent Document 2) discloses a heat-releasable adhesive sheet which exhibits a sufficient adhesiveness at the time of fixing and, after use, becomes readily releasable by curing the adhesive component with external energy such as UV irradiation or heating. However, the adhesiveness cannot be completely suppressed; therefore, there remains a problem of adhesive residue left on the adherend. Further, there is another disadvantage that the irradiation of external energy causes a harmful influence on the adherend.

Japanese Patent Application Unexamined Publication No. 2000-312862 (Patent Document 3) discloses a cleaning sheet which is intended to improve the releasability by UV irradiation as in the invention of Patent Document 2, and also has an ability to remove contaminants. However, the invention of Patent Document 3 has another problem in that a peeling charge may occur at the time of peeling the adhesive, so that dust particles are attached to the charged product.

In addition to those mentioned above, a fixing sheet using a silicone gel is also known. However, the silicone gel causes a serious contamination of the products by siloxane, and does not have a sufficient antistatic performance, so that the silicone gel attracts dust particles to cause the intrusion of foreign matters. It is conceivable to knead carbon or metal fillers into the silicone gel to impart the silicone gel with conductivity; however, there is a defect in that nonuniform distribution of carbon or metal fillers occurs, so that the distribution of electrical charge is not uniform.

Regarding the removal of contaminants, it is possible to remove the contaminants from the surface of the products by external pressure (such as air or water pressure). However, the use of air necessitates the fixation of the product, so that the process becomes cumbersome. Further, there is another disadvantage that the removal of the contaminants from the fixation surface is difficult. On the other hand, the washing with water enables the removal of the contaminants from overall surface of the electronic part; however, the recurrence of contaminant adhesion is likely to occur, and a drying step is necessary. Thus, the removal of the contaminants by external pressure has many problems.

### PRIOR ART REFERENCES

### Patent Document

Patent Document 1: Japanese Unexamined Patent Application Publication No. 2003-105290
Patent Document 2: Japanese Unexamined Patent Application Publication No. 2012-184292
Patent Document 3: Japanese Unexamined Patent Application Publication No. 2000-312862

### DISCLOSURE OF INVENTION

### Problems to be Solved by the Invention

The present invention has been made in view of the current situations as mentioned above, and the object of the present invention is to provide a temporary fixing material having a temporary fixing performance such that it can be used for temporarily fixing precision electronic parts made of glass, metals, etc. with ease, and which also can be easily removed from the adherend.

Another object of the present invention is to provide a temporary fixing material having an ability to remove contaminants adhering to an adherend such as precision electronic parts made of glass, metals, etc.

Still another object of the present invention is to provide a temporary fixing material having an antistatic performance such that it can remove a static electricity occurring at the time of removal thereof.

### Means to Solve the Problems

In order to achieve the aforementioned objects, the following inventions are provided.

Specifically, the present invention provides a temporary fixing material usable for temporarily fixing electronic parts during conveyance or processing thereof, comprising a base substrate and a polymer gel, the polymer gel comprising: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; and water having dissolved therein at least polyvinyl alcohol-type polymer, the water being retained in the polymer matrix.

The present invention also provides a temporary fixing material usable for temporarily fixing electronic parts during conveyance or processing thereof, comprising a polymer gel which comprises: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; and water having dissolved therein at least polyvinyl alcohol-type polymer, the water being retained in the polymer matrix.

Due to its specific composition, the polymer gel has a self-adhesive property and excellent flexibility. The polymer gel comprising: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; and water having dissolved therein at least polyvinyl alcohol-type polymer, the water being retained in the polymer matrix. Therefore, the polymer gel can exhibit excellent temporary fixing performance without leaving adhesive residue. Further, since the gel contains water, the polymer gel has a suitable surface resistance and exhibits excellent antistatic performance. Furthermore, due to the aforementioned self-adhesive property, the polymer gel is fixed onto the surface of an adherend such as precision electronic parts made of glass, metals, etc., and, when peeled from the adherend, can readily cause the contaminants adhered on the contact surface of the adherend to be attached to the polymer gel surface. Furthermore, since water is retained in the polymer gel, it is possible to keep foreign matters away due to the antistatic performance of the polymer gel. Therefore, the temporary fixing material of the present invention has excellent temporary fixing performance, ability to remove contaminants and antistatic performance, which can be attached to an adhered such as precision electronic parts made of glass, metals, etc., and is unlikely to be detached in spite of vibration, shaking and the like during the conveyance or processing, and which, on the other hand, can be readily removed from the adherend after the processing while removing contaminants without leaving adhesive residues nor causing the adherend to be charged.

Further, in the temporary fixing material of the present invention which comprises the base substrate and the polymer gel, the soft gel can be fixedly held by the base substrate; therefore, the temporary fixing material has excellent handling property.

In the temporary fixing material of the present invention, the polymer gel may have a peel strength of 0.1 N/20 mm to 1.0 N/20 mm for peeling from SUS at a 90° angle. When the polymer gel has a peel strength of 0.1 N/20 mm to 1.0 N/20 mm for peeling from SUS at a 90° angle, the temporary fixing material of the present invention exhibits excellent temporary fixing performance, which is unlikely to be detached even during the conveyance or processing of the electronic parts and the like that are temporarily fixed, and which can be readily removed after completion of the processing.

In the temporary fixing material of the present invention, the polymer gel may have a contaminant removal ratio of 80% or more. When the contaminant removal ratio is 80% or more, it becomes possible to easily remove contaminants adhering to an adherend such as an electronic part or a substrate, so that an effect of cleaning such an adherend can be obtained.

In the temporary fixing material of the present invention, the polymer gel may have a surface resistivity of 1.0×10⁴Ω/□ to 1.0×10⁹Ω/□. When the polymer gel has a surface resistivity of 1.0×10⁴Ω/□ to 1.0×10⁹Ω/□, the temporary fixing material of the present invention exhibits excellent antistatic performance, which is not charged when peeled from an adherend. Further, when the surface resistivity is 1.0×10⁴Ω/□ or more, the surface resistivity is not too low, so that it becomes possible to prevent the occurrence of unexpected electrical conduction through an adherend such as a precision electronic part or a substrate even when contacted with other conductive parts during the conveyance or processing, thereby enabling to protect such an adherend.

The temporary fixing material of the present invention may further comprise a release substrate provided on a side of the polymer gel opposite to a side on which the base substrate is adhered. By providing a release substrate on a side of the polymer gel opposite to a side on which the base substrate is adhered, it becomes possible to prevent the adherence of dust particles and the like which occurs due to exposure of the polymer gel. Therefore, the surface of the polymer gel on which a substrate, a precision electronic part or the like is to be adhered can be kept clean, whereby the unexpected adhesion of foreign matters to the adherend can be prevented.

### Effect of the Invention

The temporary fixing material of the present invention has a temporary fixing performance such that it can be used for temporarily fixing precision electronic parts made of glass, metals, etc. with ease, and which can be easily removed from the adherend. Further, the temporary fixing material of the present invention has an ability to remove contaminants adhering to an adherend such as a jig for fixing a precision electronic part, or a precision electronic part made of glass, metals, etc. Furthermore, the temporary fixing material of the present invention has an antistatic performance such that it can remove static electricity occurring at the time of removal thereof. In addition, with its surface resistivity being not too low, the temporary fixing material of the present invention would not harmfully affect a precision electronic part or the like.

### DETAILED DESCRIPTION OF THE INVENTION

Temporary fixing material: The temporary fixing material of the present invention includes a base substrate and a polymer gel.

The polymer gel comprises: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; and water having dissolved therein at least polyvinyl alcohol-type polymer, the water being retained in the polymer matrix.

Examples of polymerizable monomers used for forming the polymer matrix include acrylamide monomers such as (meth)acrylamide, N-methyl (meth)acrylamide, N-ethyl (meth)acrylamide, N-propyl(meth) acrylamide, N,N-dimethyl (meth)acrylamide, N,N-diethyl (meth)acrylamide, and N-isopropylacrylamide; water-soluble acrylic esters such as polyethylene glycol (meth)acrylate; vinyl amide monomers such as vinyl pyrrolidone, vinyl acetamide and vinylformamide; and nonionic monomers such as allyl alcohol. Further examples include (meth)acrylic acid or salts thereof, sulfonic acid group-containing anionic monomers such as tert-butylacrylamidesulfonic acid or salts thereof, and amino group- or ammonium group-containing cationic monomers such as dimethylaminomethylpropyl (meth)acrylamide. These monomers may be used individually or in any combination.

Among the polymerizable monomers exemplified above, those which are soluble in water are preferable since water is needed to dissolve polyvinyl alcohol-type polymers described below, and acrylamide monomers or water-soluble acrylic esters are more preferable since such monomers have excellent polymerization reactivity. Even more preferred are acrylamide monomers due to their excellent compatibility with other components of the polymer gel.

The concentration of the polymerizable monomer is preferably 10 parts by weight to 40 parts by weight, more preferably 13 parts by weight to 40 parts by weight, relative to 100 parts by weight of the total of the polymer gel. When the polymer gel is produced with the polymerizable monomer concentration of less than 10 parts by weight, the concentration of the polymer matrix in the gel is low such that a polymer gel having a sufficiently high stiffness (nerve) cannot be obtained. The resulting polymer gel is torn off when detached from an adherend and, therefore, is likely to leave a residual gel adhered to the surface of the adherend. When the concentration of the polymerizable monomer exceeds 40 parts by weight, the concentration of water for dissolving the polyvinyl alcohol type polymer decreases, so that the solubility of the polymerizable monomer may deteriorate and it may become difficult to obtain a uniform polymer gel.

The crosslinkable monomer are not particularly limited as long as it is a monomer having in its molecule at least two polymerizable carbon-carbon double bonds. Preferred examples include acrylamide type monomers and polyfunctional acrylic monomers, such as N, N′-methylene bis(meth)acrylamide, N, N′-ethylenebigmeth)acrylamide, ethylene glycol di(meth)acrylate, glycerol tri(meth)acrylate, polyethylene glycol di(meth)acrylate, polypropylene glycol di(meth)acrylate, poly(glycerol di(meth)acrylate)

The concentration of the crosslinkable monomer is preferably 0.001 part by weight to 3.0 part by weight, more preferably 0.01 part by weight to 1.0 part by weight, relative to 100 parts by weight of the total of the polymer gel. When the crosslinkable monomer concentration exceeds 3.0 parts by weight, the crosslink density of the polymer matrix becomes too high. As a result, while the stiffness (nerve) of the polymer gel increases, the gel becomes brittle, so that, for example, gel debris are likely to be attached to the adherend as contaminant at the time of cutting the temporary fixing material (sheet). On the other hand, when the crosslinkable monomer concentration is less than 0.001 part by weight, the crosslink density becomes too low, so that it becomes difficult to obtain a gelled polymer.

The polyvinyl alcohol type polymer is added for adjusting the adhesive property of the temporary fixing material while preventing occurrence of tear or residual gel as well. The specific reason for addition of the polyvinyl alcohol type polymer is that, when only adjustment of the contents of the polymerizable monomer and the crosslinkable monomer is implemented, the resulting polymer gel may not have sufficient adhesive property or may become hard and brittle, while the problem of occurrence of tear or residual gel remains unsolved. The reason for such effect available by the addition of the polyvinyl alcohol type polymer is presumed that the polyvinyl alcohol type polymer penetrates through the polymer matrix crosslinked with the polymerizable monomer and the crosslinkable monomer so as to form a gel structure called S-IPN (Semi-Interpenetrating Polymer Network), thereby increasing the flexibility of the gel structure.

Further, the retention of water having dissolved therein the polyvinyl alcohol type polymer within the polymer matrix enables to obtain an effect that the loss of water by drying of the polymer gel can be suppressed and the antistatic effect can be maintained over time.

As to the polymerization degree of the polyvinyl alcohol type polymer, it is preferable that the polymer has a viscosity average molecular weight of 500 to 3,000. When the polymerization degree is less than 500 in terms of the viscosity average molecular weight, the aforementioned effect of suppressing the tear is likely to become unsatisfactory. On the other hand, when the polymerization degree exceeds 3,000, the viscosity of the polymer increases during the dissolution thereof such that a uniformly blended monomer solution is unlikely to be obtained.

The polyvinyl alcohol type polymer preferably has a saponification degree of 80 to 98%. When the saponification degree is less than 80%, the solubility of the polymer at the preparation of the monomer blend solution improves; however, the stability of the resulting polymer gel is likely to become poor. On the other hand, when the saponification degree exceeds 98%, the solubility of the polymer becomes poor so that the preparation of the monomer blend solution becomes difficult.

The amount of the polyvinyl alcohol type polymer is preferably 0.15 part by weight to 30 parts by weight, and more preferably 5 parts by weight to 22 parts by weight, relative to 100 parts by weight of the polymer matrix in which the polymerizable monomer and the crosslinkable monomer are copolymerization-crosslinked. When the amount of the polyvinyl alcohol type polymer is less than 0.15 part by weight, the aforementioned effect of suppressing the tear becomes unsatisfactory. On the other hand, when the amount exceeds 30 parts by weight, the solubility of the polyvinyl alcohol type polymer becomes poor such that a uniform polymer gel is unlikely to be obtained.

Examples of the polyvinyl alcohol type polymer include polyvinyl alcohol, an ethylene-polyvinyl alcohol copolymer, derivatives of polyvinyl alcohol, and a modified polyvinyl alcohol. The polyvinyl alcohol type polymer is preferably constituted of linear polymer molecules. This is because the S-IPN structure can be easily obtained.

The amount of water contained in the polymer gel is preferably 40 to 460 parts by weight, relative to 100 parts by weight of the polymer matrix. When the amount of water is less than 40 parts by weight, the dissolution of the polyvinyl alcohol type polymer may become difficult. On the other hand, when the amount of water exceeds 460 parts by weight, the dissolution of the polyvinyl alcohol is easy; however, the amount of water is likely to surpass the amount of water that can be retained by the polymer matrix so that the resultant product becomes susceptible to change in property by drying.

For improving the moisture retention property and plasticity, it is preferred that the polymer gel contains a polyhydric alcohol. Examples of the polyhydric alcohol include diols such as ethylene glycol, propylene glycol, and butanediol; polyhydric alcohols such as glycerol, pentaerythritol, and sorbitol; polyhydric alcohol condensates such as polyethylene glycol, polypropylene glycol, and polyglycerin; and modified polyhydric alcohols such as polyoxyethylene glycerin. Preferred are polyhydric alcohols which are in a liquid state at room temperature, more specifically, within a temperature range for actual use of the polymer gel (e.g., around 20° C. when the polymer gel is used in a room).

The concentration of the polyhydric alcohol is preferably 580 parts by weight or less, relative to 100 parts by weight of the polymer matrix. The concentration of the polyhydric alcohol is more preferably 100 parts by weight to 580 parts by weight because it becomes possible to impart the resulting polymer gel with a moisture retention property and suppress the unintended modification of properties by drying, so that the flexibility and antistatic property which are inherently possessed by the polymer gel can be exhibited for a longer period of time. When the concentration of the polyhydric alcohol exceeds 580 parts by weight, the water content of the polymer gel relatively becomes low so that the dissolution of the polyvinyl alcohol type polymer into the polymer gel becomes difficult.

The polymerization initiator is not particularly limited. When the polymerization-crosslinking is performed by heating, an azo-polymerization initiator such as azobis(cyanovaleric acid) or azobis(amidinopropane)dihydrochloride can be used. Alternatively, when the polymerization is performed by photoirradiation, any of conventional photopolymerization initiators represented by azo-type initiators and acetophenone-type initiators can be used. Further, the polymerization may be performed by simultaneous application of photoirradiation and heating in the presence of a mixture of two or more of the aforementioned polymerization initiators.

Alternatively, it is also possible to use, for example, redox polymerization initiators comprising a reducing agent such as ferrous sulfate or a pyrosulfite, and a peroxide such as hydrogen peroxide or persulfate. When such redox polymerization initiators are used, the reaction can be implemented even without heating; however, it is preferred to implement the reaction while heating for reducing the residual monomers and reducing the reaction time.

If necessary, the polymer gel may contain any of various conventional additives. Examples of the additives include antioxidants, stabilizers, pH adjusters, aromatizers, colorants and dyes.

As an example of a method for producing the polymer gel, there can be mentioned the following method.

A polymerizable monomer having in its molecule at least one polymerizable carbon-carbon double bond, a crosslinkable monomer having in its molecule at least two polymerizable carbon-carbon double bonds, a polyvinyl alcohol type polymer, water and, if necessary, a polymerization initiator or an additive are uniformly mixed together and dissolved, to thereby obtain a monomer blend solution. Then, the polymerizable monomer and the crosslinkable monomer are polymerization-crosslinked to obtain the polymer gel. Since the monomer blend solution is liquid, a polymer gel having a desired shape can be formed by, for example, pouring the monomer blend solution into a resin mold etc. where the polymerization-crosslinking reaction is implemented. Further, when the monomer blend solution is poured into a gap between two films held with a predetermined interval therebetween, and a polymerization-crosslinking reaction is implemented, a polymer gel of a sheet shape can be obtained.

Example of a method for polymerization-crosslinking the polymerizable monomer and the crosslinkable monomer include a method involving heating or photoirradiation, and a method involving irradiation of electron beam, gamma ray, etc. However, the latter method involving irradiation requires a special facility for irradiation; therefore, the former method involving heating or photoirradiation is more preferable. When such method is employed, the production process is simple and a continuous production is possible; therefore, a very high economical advantage is available and a polymer gel with the same properties can be stably obtained.

As to the adhesive property of the polymer gel, the polymer gel preferably has a peel strength of 0.1 N/20 mm to 1.0 N/20 mm for peeling from SUS at a 90° angle, wherein the peel strength is a stress at the time of peeling from a SUS plate (stainless steel plate) at a 90° angle. When the peel strength is outside the aforementioned range, the balance between adhesive property and reworkability may be lost. For example, when the peel strength exceeds 1.0 N/20 mm, a high adhesive property can be obtained; however, the peeling becomes difficult so that the reworkability may be lost, whereas, when the peel strength is less than 0.1 N/20 mm, a sufficient adhesive property cannot be obtained. Further, the ability to remove contaminants is also lost such that it becomes difficult to achieve a contaminant removal ratio of 80% or more.

As to the electric property of the polymer gel, it is preferred that the surface resistivity of the polymer gel is 1.0×10⁴Ω/□ to 1.0×10⁹Ω/□. For example, when the surface resistivity exceeds 1.0×10⁹, a sufficient antistatic performance cannot be obtained, so that dust particles may be attracted and adhere to the products as contaminants. When the surface resistivity is less than 1.0×10⁴Ω/□, electronic parts may be harmfully influenced.

The polymer gel is generally formed as a result of gelation caused by polymerization of the liquid monomer blend solution, so that the polymer gel can be formed into an appropriate shape depending on the use. For example, when it is formed in the form of a polymer gel sheet, the thickness thereof is preferably 0.01 mm to 5.0 mm. When the thickness is less than 0.01 mm, the handling property of the sheet becomes poor.

The base substrate is a part for carrying the polymer gel thereon and for maintaining the shape of the temporary fixing material to improve the handling property of the temporary fixing material.

As the base substrate, it is preferred to use a resin film because the polymer gel can be reinforced and the temporary fixing material can be maintained to be in a tape shape. Examples of the resin film include films of resins such as a polyester, a polyolefin, a polystyrene and a polyurethane. More preferable resin films include biaxially oriented PET film and OPP.

The base substrate is unified with the polymer gel to obtain a temporary fixing material to be attached to and removed from a precision part or the like; however, the end user may use the base substrate after removing it from the polymer gel.

The temporary fixing material of the present invention may further comprise a release substrate provided on a side of the polymer gel opposite to a side on which the base substrate is adhered. For preventing the dust partides from adhering to the polymer gel, it is preferred that the base sheet is adhered on the polymer gel shaped into a sheet, while providing a release substrate on a surface of the polymer gel which is opposite to the side on which the base sheet is provided.

The release substrate as a separator is to be removed from the polymer gel by the end user before the temporary fixing material is attached to or removed from a precision part or the like. As a material for the release substrate, a resin formable into a sheet or a paper can be used. For example, the release substrate may be a resin sheet made of a polyester, a polyolefin, a polystyrene or the like.

With respect to the release substrate, it is preferred that the release substrate is release-treated on its contact surface with the polymer gel so as to allow easy removal of the release substrate from the surface of the polymer gel. Further, if necessary, the release substrate may be release-treated on both surfaces thereof. When the both surfaces of the release substrate are release-treated, the treatment may be implemented such that the releasability differs between the surfaces of the release substrate.

As an example of the release treatment, there can be mentioned a surface treatment in which the surface of the release substrate is coated with a release agent such as a fluororesin, a silicone resin, and a long chain alkyl group-containing carbamate. Especially, a silicone-coating of a baking finish type in which a crosslinking-curing reaction is caused by heat or ultraviolet light is preferred in that the release agent is unlikely to migrate to the polymer gel from the surface of the release substrate.

Similarly, the base substrate may be release-treated in the same manner as mentioned above.

Further, the base substrate and/or the release substrate may be antistatic-treated, depending on the use of the temporary fixing material. Examples of the antistatic treatment include a treatment in which the surface of the release substrate is coated with a surfactant, a conductive polymer or the like, and a treatment in which carbon, metal particles or the like is kneaded into the release substrate. As to the antistatic performance, it is preferred that the surface resistivity is 1×10⁴Ω/□ to 1×10¹²Ω/□. The surface resistivity within this range is effective for preventing the temporary fixing material, when removed from an adherend, from being electrically charged, thereby keeping the products away from dust, and for preventing the electronic parts from being harmfully influenced by too low a resistance.

The thickness of each of the base substrate and the release substrate can be appropriately selected within the range of 0.01 mm to 0.2 mm, depending of the use of the temporary fixing material. Further, since the preferred thickness of the polymer gel is 0.01 mm to 5.0 mm, the total thickness of the temporary fixing material is preferably about 0.02 mm to 5.2 mm in the case where the release substrate is absent, and is preferably about 0.03 mm to 5.4 mm in the case where the release substrate is present.

When the base substrate or the release substrate is required to be flexible, it is preferred to use a thin film. When the base substrate or the release substrate is required to be rigid, it is preferred to use a thick film. Further, when a polymer gel having a thickness of less than 0.1 mm is to be tightly attached to an adherend such as a substrate having a relatively flat surface or a precision electronic part, it is preferred that the base substrate has a high hardness because the tight attachment of the polymer gel to the adherend without intrusion of air therebetween becomes easy.

As an example of a method for producing the temporary fixing material, there can be mentioned the following method.

A monomer blend solution prior to polymerization to form a polymer gel is prepared, and the solution (composition) is poured into a mold having a predetermined shape, followed by polymerization to obtain a polymer gel. The obtained polymer gel and the base substrate are unified by, for example, placing the polymer gel on the base substrate or binding the base substrate to the polymer gel. Thus, the temporary fixing material can be obtained.

Alternatively, the temporary fixing material can be produced by a method in which a monomer blend solution prior to polymerization to form a polymer gel is applied onto the base substrate, followed by polymerization while maintaining the thickness of the polymer gel at a predetermined level. When the release substrate is used in combination with the base substrate, the temporary fixing material can be produced by a method in which the monomer blend solution is poured into a gap between the base substrate and the release substrate which are retained with a predetermined interval therebetween, followed by polymerization.

The aforementioned temporary fixing material has a temporary fixing performance such that it can be used for temporarily fixing precision electronic parts made of glass, metals, etc. with ease, and which can be easily removed from the adherend. Further, the temporary fixing material has an ability to remove contaminants adhering to an adherend such as a jig for fixing a precision electronic part, or a precision electronic part made of glass, metals, etc. Furthermore, the temporary fixing material of the present invention has an antistatic performance such that it can remove static electricity occurring at the time of removal thereof.

Further, in a step of producing or processing electronic parts such as a semiconductor or a glass chip, the aforementioned temporary fixing material can be used for temporarily fixing such parts and the like. Especially, when the temporary fixing material is in the form of a sheet having a thickness of about 0.3 to 2.0 mm, the temporary fixing material can be suitably used for temporarily fixing minute products among those mentioned above to parts for conveyance, such as a conveyance container or a conveyance tray.

Example of modification: In the embodiment mentioned above, the temporary fixing material comprises the base substrate, the polymer gel and, optionally, the release substrate; however, alternatively, the polymer gel alone can be used as a temporary fixing material.

In this case, however, it is difficult to achieve a tight attachment of the polymer gel used alone as a temporary fixing material to a thin adherend, and it is preferred to use the polymer gel in the form of a mass which excels in handling property.

### EXAMPLES

Hereinbelow, the present invention will be described in more detail with reference to the Examples.

### Experimental Example 1

24 parts by weight of acrylamide as the polymerizable monomer, 0.05 part by weight of N, N′-methylenebisacrylamide as the crosslinkable monomer, 45 parts by weight of glycerol which is a polyhydric alcohol as a plasticizer or a wetting agent, and 3 parts by weight of polyvinyl alcohol with a viscosity average polymerization degree of 1,800 and a saponification degree of 88% (“Poval VP-18 (trade name) manufactured by Japan VAM & POVAL Co., Ltd.) as the polyvinyl alcohol type polymer, and water were mixed such that the total amount of the resulting mixture became 99.9 parts by weight, followed by stirring to obtain a solution. Then, as a photopolymerization initiator, 0.1 part by weight of 1-[4-(2-hydroxyethoxy)-phenyl]-2-hydroxy-2-methyl-propan-1-one (“IRUGACURE2959 (trade name)” manufactured by BASF Japan Ltd.) was added to the obtained 99.9 parts by weight of the solution (composition), followed by stirring to obtain a monomer blend solution. The obtained monomer blend solution was dropwise added onto a 100 μm-thick polyethylene terephthalate film (base substrate), and the resultant coating on the film was covered with a 38 μm-thick silicone-coated polyethylene terephthalate film (separator). Then, the resultant structure was fixed such that the polymer blend solution was caused to uniformly expand between the films so as to obtain a polymer gel layer having a thickness of 0.3 mm. Using a metal halide lamp, the resultant was irradiated with ultraviolet light having an energy of 2,000 mJ/cm² using a metal halide lamp to perform a polymerization-crosslinking reaction, thereby obtaining a temporary fixing material (sample 1) having the base substrate on one side and the separator attached on the other side, and having a thickness of 438 μm.

### Experimental Examples 2 to 7

In Experimental Examples 2 to 7, samples 2 to 7 (temporary fixing materials) were produced in the same manner as in Experimental Example 1 except that the monomer blend solutions having respective compositions as shown in Table 1 were used instead of the monomer blend solution used in Experimental Example 1. The electrolyte blended in Experimental Example 6 was sodium chloride.

### Experimental Examples 8 and 9

In each of Experimental Examples 8 and 9, an acrylic adhesive or a silicone gel was used instead of the polymer gel obtained in Experimental Example 1 by polymerization-crosslinking reaction of the monomer blend solution, and the acrylic adhesive or the silicone gel was attached to the same base substrate as used in Experimental Example 1. The thicknesses of the separator, the adhesive and the gel were the same as in Experimental Example 1. Thus, temporary fixing materials as samples 8 and 9 were obtained. Here, an antistatic polyester adhesive sheet 6671#25 (manufactured by Teraoka Seisakusho Co., Ltd.) was used as the acrylic adhesive, and Gel film 0 (manufactured by Gel-Pak, Inc.) was used as the silicone gel.

### Experimental Example 10

In Experimental Example 10, the monomer blend solution obtained in Experimental Example 1 was poured into a mold, followed by irradiation with ultraviolet light in the same manner as in Experimental Example 1. Then, the resulting polymer gel was taken out from the mold. Thus, a temporary fixing material as sample 10 was prepared, which was formed of a plate-shaped polymer gel having a thickness of 300 μm, and which had neither the base substrate nor the separator.

The respective compositions of samples 1 to 10 obtained in Experimental Examples 1 to 10 are shown in Table 1. In Table 1, all amounts are expressed in terms of part by weight.

TABLE 1

| | | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|---|
| | | | Sam- | Sam- | Sam- | Sam- | Sam- | Sam- | Sam- | Sam- | Sam- | Sam- |
| | Component | | ple 1 | ple 2 | ple 3 | ple 4 | ple 5 | ple 6 | ple 7 | ple 8 | ple 9 | ple 10 |
| Amount | Polymerizable monomer | | 24 | 13 | 40 | 10 | 25 | 24 | 24 | — | — | 24 |
| | Crosslinkable monomer | | 0.05 | 0.5 | 0.05 | 0.5 | 3 | 0.05 | 0.05 | — | — | 0.05 |
| | Glycerol | | 45 | 65 | 27.68 | 45 | 45 | 40 | 48 | — | — | 45 |
| | Water | | 27.85 | 18.4 | 30.17 | 41.4 | 23.9 | 27.85 | 27.85 | — | — | 27.85 |
| | Polyvinyl alcohol | | 3 | ← | 2 | 3 | ← | ← | 0 | — | — | 3 |
| | Photopolymerization initiator | | 0.1 | ← | ← | ← | ← | ← | ← | — | — | 0.1 |
| | Electrolyte | | — | — | — | — | — | — | — | — | — | — |
| | Acrylic adhesive | | — | — | — | — | — | — | — | 100 | — | — |
| | Silicone gel | | — | — | — | — | — | — | — | — | 100 | — |
| Base substrate | | | Yes | ← | ← | ← | ← | ← | ← | ← | ← | No |
| Evaluation | Temporary fixing | Peel strength | 0.16 | 0.17 | 0.15 | 0.22 | 0.16 | 0.21 | 0.27 | 3.3 | 0.1 | 0.16 |
| | performance | (N/20 mm) | ◯ | ◯ | ◯ | ◯ | ◯ | ◯ | ◯ | X | ◯ | ◯ |
| | | Adhesive | ◯ | ◯ | ◯ | Δ | Δ | ◯ | X | X | ◯ | ◯ |
| | | residue | | | | | | | | | | |
| | Ability to remove | Contaminant | ◯ | ◯ | ◯ | ◯ | ◯ | ◯ | — | — | — | Δ |
| | contaminants | removal ratio | | | | | | | | | | |
| | Antistatic | Surface | 2.07 × | 1.13 × | 8.70 × | 8.01 × | 8.90 × | 3.60 × | 4.14 × | 6.00 × | Not | 2.07 × |
| | performance | resistivity (Ω/□) | 10⁵ | 10⁶ | 10⁵ | 10⁴ | 10⁵ | 10³ | 10⁵ | 10⁸ | mea- | 10⁵ |
| | | | ◯ | ◯ | ◯ | ◯ | ◯ | Δ | ◯ | ◯ | surable | ◯ |
| | | | | | | | | | | | X | |

### [Performance Evaluation Method]

With respect to each of the samples 1 to 10 (temporary fixing materials) obtained in the aforementioned Experimental Examples 1 to 10, the temporary fixing performance, ability to remove contaminants and antistatic performance were evaluated by the following measurements and observations. The results are also shown in Table 1.

### (1) Temporary Fixing Performance

The temporary fixing performance was evaluated based on the peel strength (adhesiveness) and the adhesive residue.

i) Peel Strength for Peeling from SUS at a 90° Angle:

Each sample was cut into a piece of 20 mm in width and 120 mm in length, followed by removal of the polyethylene terephthalate film as the separator, to obtain a test piece composed of the base substrate and the polymer gel. To sample 10, the same base substrate as used in the other samples was attached. Then, the obtained test piece was attached, on its polymer gel side, to an adherend that was a SUS 304 grade stainless steel mirror-finished with #800, and a pressing roller of 2 kg was reciprocated once on the resulting laminate, thereby pressure-bonding the test piece to the adherend. An end of the test piece (the short side) was fixed with a chuck, and the stress at the time of peeling at a 90° angle (peel strength) (N/20 mm) was measured using a TENSILON universal testing machine (“RTE-1210 (trade name)” manufactured by Orientec Corporation) at a temperature of 23±5° C., a humidity of 55±10% and a test speed of 300 mm/min. The results were evaluated in terms of the following classifications: “◯” when the peel strength was 0.1 N/20 mm to 1.0 N/20 mm, and “x” when the peel strength was less than 0.1 N/20 mm or more than 1.0 N/20 mm.

### ii) Adhesive Residue:

After the measurement of the aforementioned “i) Peel strength”, an observation was made to check whether or not a part of the polymer gel was left as an adhesive residue on the surface of the SUS plate. The results were evaluated in terms of the following classifications: “◯” when the polymer gel was completely removed without leaving an adhesive residue, and the surface of the SUS plate appeared to be the same as that before the measurement, “Δ” when no adhesive residue was observed but the surface condition of the SUS plate appeared to be slightly different from that before the measurement, for example, as in the case where the surface was hazed, and “x” when an adhesive residue was observed.

### (2) Ability to Remove Contaminants

The ability to remove contaminants was evaluated based on the contaminant-removal ratio measured by the following method.

iii) Contaminant-Removal Ratio:

Each sample was cut into a piece of 30 mm×30 mm, followed by removal of the polyethylene terephthalate film as the separator, to obtain a test piece composed of the base substrate and the polymer gel. Then, acrylic particles having an average particle diameter of 200 μm (obtained by on-off cutting Techpolymer MBX-200 (average particle diameter: 200 μm, manufactured by Sekisui Plastics Co., Ltd.) with 180 mesh and 250 mesh) were spread over a 2 mm×2 mm section of a SUS 304 grade stainless steel mirror-finished with #800 (SUS plate). Onto the surface of the SUS plate covered with the acrylic particles was attached the obtained test piece on its polymer gel side, and a pressing roller of 2 kg was reciprocated once on the resulting laminate, thereby pressure-bonding the test piece to the SUS plate. After being allowed to stand for 5 minutes, the test piece was peeled off and a photomicrograph (100-fold magnification) of a portion of the SUS plate to which the test piece had been attached was taken through a digital microscope (KEYENCE, VH-5000), and the number of the acrylic particles left on the SUS plate was counted. Based on the relationship between the counted number of the acrylic particles and the number of the acrylic particles before the attachment of the test piece, a transfer adhesion ratio was calculated as the contaminant removal ratio (%) by the following formula.

With respect to sample 10, after being cut into a piece of 30 mm×30 mm, the resultant sample piece was attached to the surface of the SUS plate which was covered with the aforementioned acrylic particles. Further, the same film as the base substrate used in other samples was placed on the sample piece, followed by pressure-bonding by a pressing roller in the same manner as in the case of other samples. Otherwise, the determination of the contaminant removal ratio was carried out in the same manner as in other samples.

Contaminant removal ratio (%)=(1−AN/BN)×100 [Chemical formula 1]

wherein “AN” represents the number of acrylic particles left on the SUS plate (within a 2 mm×2 mm section) after peeling of the test piece, and “BN” means the number of acrylic particles present on the SUS plate (within a 2 mm×2 mm section) before peeling of the test piece.

With respect to the acrylic particles present on the SUS plate (within a 2 mm×2 mm section) before peeling of the test piece, the number thereof was set to be 60 or more.

The results were evaluated in terms of the following classifications: “◯” when the contaminant removal ratio was 80% or more, “x” when the contaminant removal ratio was less than 80%, and “Δ” when air intruded between the SUS plate and the test piece unless the test piece was carefully attached onto the SUS plate, so that the test results fluctuated and, therefore, the calculation of the contaminant removal ratio was difficult.

With respect to each of the samples 7 to 9, the temporary fixing performance and the antistatic performance were so poor that the tests were omitted.

### (3) Antistatic Performance

The antistatic performance was evaluated based on the surface resistivity of the polymer gel.

### iv) Surface Resistivity:

Each sample was cut into a piece having an area of at least 100 mm×100 mm, followed by removal of the polyethylene terephthalate film as the separator, to obtain a test piece. As to sample 10, this sample was cut into a piece having an area of at least 100 mm×100 mm, which was used as a test piece. The surface resistivity (Ω/□) was measured on the polymer gel, using a surface resistance meter (main body: Model-152, probe: 152P-CR, manufactured by Trek Japan Co. Ltd.) The conditions for the measurement were: a temperature of 23±5° C., and a humidity of 55±10%. The results were evaluated in terms of the following classifications: “◯” when the surface resistivity was 1.0×10⁴Ω/□ to 1.0×10⁹Ω/□, and “x” when the surface resistivity was more than 1.0×10⁹Ω/□, and “Δ” when the surface resistivity was less than 1.0×10⁴Ω/□. The reason for classification “Δ” is that the antistatic performance is satisfactory but the surface resistivity is low such that the electronic parts may be harmfully influenced.

### [Results of Performance Evaluation]

The results of the performance evaluation of each sample were as shown in Table 1, based on which the following observations were made.

The temporary fixing materials as samples 1 to 3 excelled in respect of all of the temporary fixing performance, ability to remove contaminants and antistatic performance.

In the case of sample 4 in which the content of the polymerizable monomer was below the lower limit (13 parts by weight) of the preferred range and sample 5 in which the content of the crosslinkable monomer exceeded the upper limit (1.0 part by weight) of the preferred range, the occurrence of adhesive residue was evaluated as “Δ”. That is, the adhesive residue was not observed but the appearance of the surface of the adherend changed slightly. However, each of samples 4 and 5 excelled in respect of all of the temporary fixing performance, ability to remove contaminants and antistatic performance.

In the case of sample 6 which contained sodium chloride as electrolyte, the surface resistivity was below 1.0×10⁴Ω/□. However, sample 6 excelled in respect of all of the temporary fixing performance, ability to remove contaminants and antistatic performance.

In the case of sample 7 which did not contain the polyvinyl alcohol type polymer, an adhesive residue was observed, thereby indicating the possibility of contaminating the adherend.

In the case of sample 8 using the acrylic adhesive instead of the polymer gel, the peel strength was high and an adhesive residue was observed, thereby indicating the possibility of contaminating the adherend.

Sample 9 using a silicone gel instead of the polymer gel had an unmeasurably high surface resistivity and had a poor antistatic performance.

In the case of sample 10 which was formed only of the polymer gel without using the base substrate, the attachment of the polymer gel to the adherend had to be carried out carefully. This is because the polymer gel with a thickness of 300 μm is caused to be twisted unless carefully attached to the adherend, which may result in intrusion of air between the adherend and the polymer gel. However, besides such worsening of handling, sample 10 excelled in respect of all of the temporary fixing performance, ability to remove contaminants and antistatic performance.

[Performance Evaluation Method 2]

With respect to each of the samples 1 to 10 (temporary fixing materials) obtained in the aforementioned Experimental Examples 1 to 10, the temporary fixing performance thereof with respect to minute products handled in the production of precise electronic parts was evaluated by the following method.

Each sample was cut into a piece of 30 mm×30 mm, followed by removal of the separator. On the polymer gel of the resultant sample was placed a commercially available glass chip (cube of 5 cm×5 cm×5 cm or smaller) with tweezers. Then, the sample was placed in a plastic container which was prepared in advance, and the container was sealed. Here, in the case of the sample with the base substrate, the base substrate thereof was adhered to the plastic container by a double-sided tape, while the sample without the base substrate was adhered, on its side opposite to the side on which the glass chip was placed, to the plastic container.

The plastic container was dropped from a height of 1 m, and a visual observation was made to check whether or not the glass chip was displaced (drop test). Further, another observation was made to evaluate pick-up property (easiness of removal) for removing the glass chip from the polymer gel with tweezers.

As to the drop test, good results were achieved with respect to all of the samples, where no displacement of the glass chip occurred.

As to the pick-up test, good results were achieved with respect to samples 1 to 3, 5, 6 and 10, where the glass chip could be easily removed from the polymer gel. With respect to sample 4, the pick-up property thereof was at a satisfactory level, but the glass chip could be removed after the polymer gel was brought up slightly with the glass chip. On the other hand, sample 7 left an adhesive residue on the surface of the glass chip, sample 8 was strongly adhered to the glass chip such that the glass chip could not be removed, and sample 9 had a poor pick-up property where the polymer gel was brought up with the glass chip.

### INDUSTRIAL APPLICABILITY

The temporary fixing material of the present invention can be used for temporarily fixing various parts such as a lead frame and a module using a metal plate or an electroplated product, to which dust particles may be attached by static electricity in a step of producing or processing precision electronic parts such as a semiconductor, especially in a step performed in a clean room, and also can be used for covering such parts to prevent contaminants from being attached to the parts. Further, besides the use in the processing of the products, the temporary fixing material of the present invention can also be used after the processing for removing the contaminants which had been attached to the products during the processing step such as polishing.

1. A temporary fixing material usable for temporarily fixing electronic parts during conveyance or processing thereof, comprising a base substrate and a polymer gel,
the polymer gel comprising: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; and water having dissolved therein at least polyvinyl alcohol-type polymer, the water being retained in the polymer matrix.

2. The temporary fixing material according to claim 1, wherein the polymer gel has a peel strength of 0.1 N/20 mm to 1.0 N/20 mm for peeling from SUS at a 90° angle.

3. The temporary fixing material according to claim 1, wherein the polymer gel has a contaminant removal ratio of 80% or more.

4. The temporary fixing material according to claim 1, wherein the polymer gel has a surface resistivity of 1.0×10⁴Ω/□ to 1.0×10⁹Ω/□.

5. The temporary fixing material according to claim 1, which further comprises a release substrate provided on a side of the polymer gel opposite to a side on which the base substrate is adhered.

6. A temporary fixing material usable for temporarily fixing electronic parts during conveyance or processing thereof, comprising a polymer gel,
the polymer gel comprising: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; and water having dissolved therein at least polyvinyl alcohol-type polymer, the water being retained in the polymer matrix.

7. The temporary fixing material according to claim 2, wherein the polymer gel has a contaminant removal ratio of 80% or more.

8. The temporary fixing material according claim 2, wherein the polymer gel has a surface resistivity of 1.0×10⁴Ω/□ to 1.0×10⁹Ω/□.

9. The temporary fixing material according claim 3, wherein the polymer gel has a surface resistivity of 1.0×10⁴Ω/□ to 1.0×10⁹Ω/□.

10. The temporary fixing material according claim 7, wherein the polymer gel has a surface resistivity of 1.0×10⁴Ω/□ to 1.0×10⁹Ω/□.

11. The temporary fixing material according to claim 2, which further comprises a release substrate provided on a side of the polymer gel opposite to a side on which the base substrate is adhered.

12. The temporary fixing material according to claim 3, which further comprises a release substrate provided on a side of the polymer gel opposite to a side on which the base substrate is adhered.

13. The temporary fixing material according to claim 4, which further comprises a release substrate provided on a side of the polymer gel opposite to a side on which the base substrate is adhered.

14. The temporary fixing material according to claim 7, which further comprises a release substrate provided on a side of the polymer gel opposite to a side on which the base substrate is adhered.

15. The temporary fixing material according to claim 8, which further comprises a release substrate provided on a side of the polymer gel opposite to a side on which the base substrate is adhered.

16. The temporary fixing material according to claim 9, which further comprises a release substrate provided on a side of the polymer gel opposite to a side on which the base substrate is adhered.

17. The temporary fixing material according to claim 10, which further comprises a release substrate provided on a side of the polymer gel opposite to a side on which the base substrate is adhered.
